(19) United States
(12) Patent Application Publication
(10) Pub. No.: US 2025/0111734 A1
(43) Pub. Date: Apr. 3, 2025

(54) GAMING SYSTEMS AND METHODS USING ACTIVATION ZONES AND CATALYST TRIGGERS

(71) Applicant: LNW Gaming, Inc., Las Vegas, NV (US)

(72) Inventors: Sarah LEGGETT, Chicago, IL (US); Jeremy HORNIK, Chicago, IL (US)

(21) Appl. No.: 18/888,898

(22) Filed: Sep. 18, 2024

Related U.S. Application Data
(60) Provisional application No. 63/587,214, filed on Oct. 2, 2023.

(51) Int. Cl. G07F 17/32; G07F 17/34

(52) U.S. Cl. CPC G07F 17/3213; G07F 17/3267; G07F 17/34

(57) ABSTRACT

There is provided a gaming system, gaming machine, and method that utilize game-logic circuitry in communication with a presentation assembly configured to present a plurality of symbol positions, a catalyst game element, and a plurality of game outcomes. For each game outcome, the presentation assembly is configured to present a zone outcome visually indicating an activation zone within the symbol positions, present a symbol outcome by populating the symbol positions with randomly selected symbols, visually update, in response to the randomly selected symbols including one or more value-bearing symbols within the activation zone, the value-bearing symbols to an active state, present a catalyst outcome with the catalyst game element, and present, in response to detecting a catalyst trigger within the catalyst outcome, an award sequence for an award at least partially as a function of the award indicia of any active state value-bearing symbols within the symbol positions.

### CROSS-REFERENCE TO RELATED APPLICATIONS

This application claims the benefit of priority to U.S. Provisional Application No. 63/587,214, filed Oct. 2, 2023, the contents of which are hereby incorporated by reference in their entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2023, LNW Gaming, Inc

### FIELD OF THE INVENTION

The present invention relates to a technological improvement to gaming systems, gaming machines, and methods and, more particularly, to new and improved animations in connection with a game feature including activation zones and catalyst triggers.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

According to an embodiment of the present invention, there is provided a gaming system, gaming machine, and method that utilize game-logic circuitry in communication with a presentation assembly configured to present a plurality of symbol positions, a catalyst game element, and a plurality of game outcomes. For each game outcome, the presentation assembly is configured to present a zone outcome visually indicating an activation zone within the symbol positions, present a symbol outcome by populating the symbol positions with randomly selected symbols, visually update, in response to the randomly selected symbols including one or more value-bearing symbols within the activation zone, the value-bearing symbols to an active state, present a catalyst outcome with the catalyst game element, and present, in response to detecting a catalyst trigger within the catalyst outcome, an award sequence for an award at least partially as a function of the award indicia of any active state value-bearing symbols within the symbol positions.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a block diagram of a gaming system according to an embodiment of the present invention.

FIG. 3 is an example game interface of a gaming system according to an embodiment of the present invention.

FIG. 4 is a block flow diagram of an example method of operating a gaming machine of a gaming system, according to an embodiment of the present invention.

FIG. 5 is a block diagram of another example method of operating a gaming machine of a gaming system, according to an embodiment of the present invention.

FIG. 6A depicts an example game interface in a first state with a trigger event, according to an embodiment of the present invention.

FIG. 6B depicts the game interface shown in FIG. 6A in a second state initiating a feature game, according to an embodiment of the present invention.

FIG. 6C depicts the game interface shown in FIG. 6A in a third state with a first feature game outcome, according to an embodiment of the present invention.

FIG. 6D depicts the game interface shown in FIG. 6A in a fourth state with a second feature game outcome, according to an embodiment of the present invention.

FIG. 6E depicts the game interface shown in FIG. 6A in a fifth state with a catalyst trigger event, according to an embodiment of the present invention.

FIG. 6F depicts the game interface shown in FIG. 6A in a fifth state with an award sequence, according to an embodiment of the present invention.

FIG. 7A depicts an example game interface with a multiplier catalyst, according to an embodiment of the present invention.

FIG. 7B depicts the game interface shown in FIG. 7A with value-bearing symbols having updated award indicia in response to the multiplier catalyst, according to an embodiment of the present invention.

FIG. 8 depicts an example game interface with a non-uniform activation zone, according to an embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

Embodiments of the present invention comprise an innovative application of data processing steps that, when implemented by game-logic circuitry, direct an electronic display device to present a symbol-value accumulation process that minimizes processing overhead by utilizing numbered indicia to represent credit values instead of complex, fanciful game images. Further, the process aggregates displayed values borne by special symbols (i.e., value-bearing symbols) according to stored, variable criteria. In this way, the value-bearing symbols provide building blocks for innumerable different aggregation sequences simply by manipulating the aggregation criteria associated with the value-bearing symbols, resulting in fewer rules needed for the aggregation process than would be necessary for calculating values of winning symbol combinations enumerated in stored paytables, as found in prior art reel-spinning routines. At the same time, embodiments of the present invention provide a straightforward, what-you-see-is-what-you-get (WYSIWYG) visual presentation that is simple to understand and, therefore, effective in generating player excitement and enthusiasm. The result is a highly flexible value-aggregation process that can be easily adapted to any theme/brand while remaining easily understood by players.

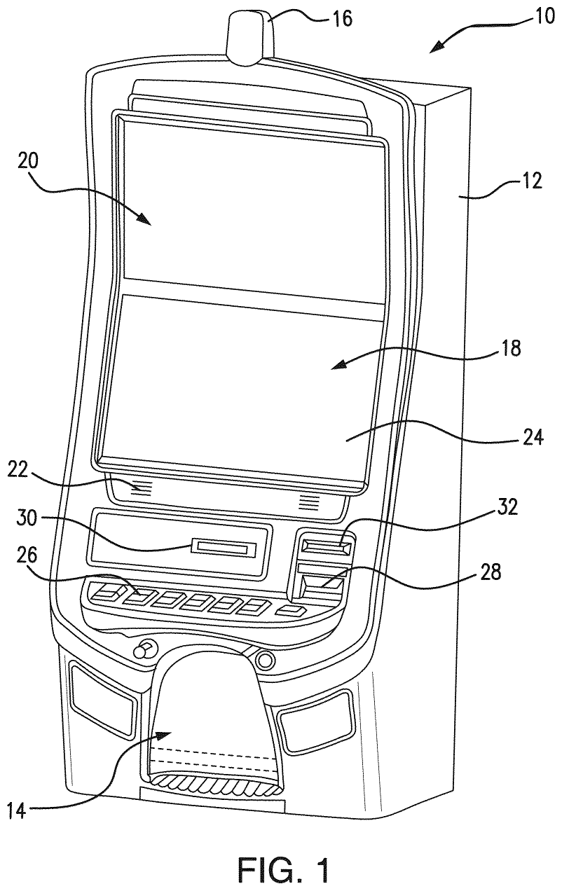

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls, and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical-reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

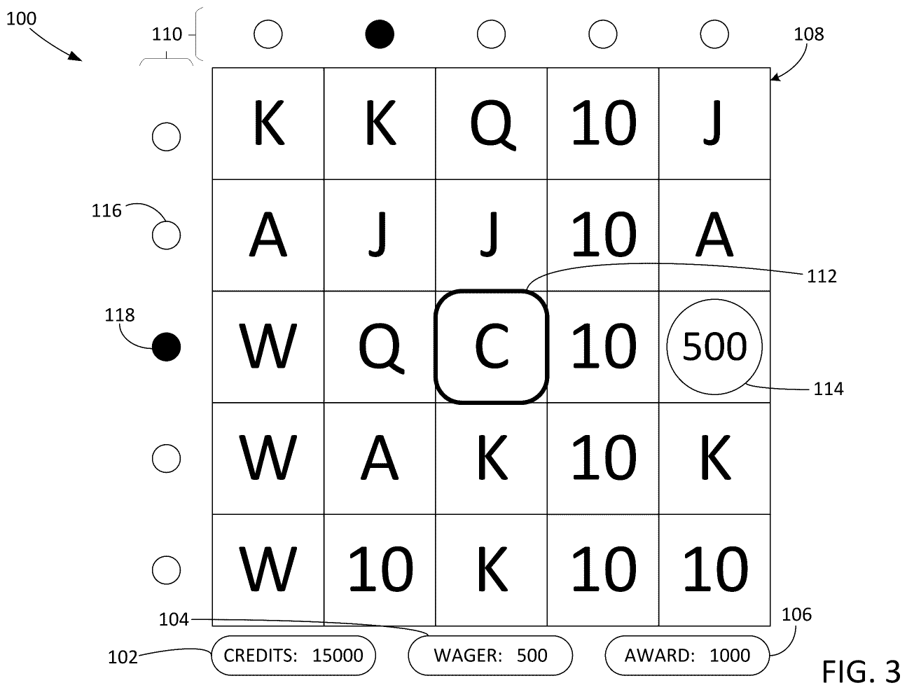

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter (e.g., the meter 102, shown in FIG. 3). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter, the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

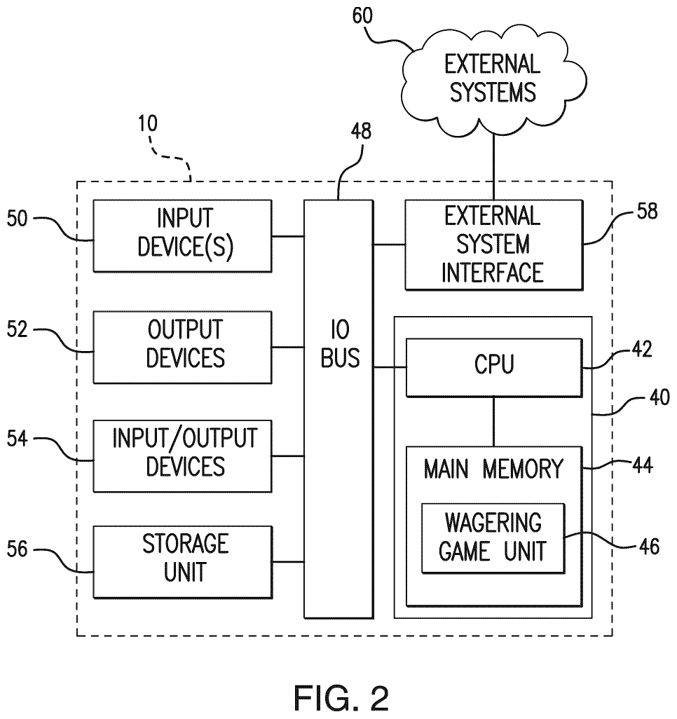

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40-whether located within (“thick client”), external to (“thin client”), or distributed both within and external to (“intermediate client”) the gaming machine 10-is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compares it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accord with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be implemented with hardware and software architectures, circuitry, and other special features that differentiate it from general-purpose computers (e.g., desktop PCs, laptops, and tablets).

The gaming systems and methods described herein include game outcomes formed from a plurality of sub outcomes. Each sub-outcome is distinctive from other sub-outcomes and incorporates at least one unique game element. However, these sub-outcomes are interconnected to each other such that one sub-outcome alters or otherwise affects the game elements used within another sub-outcome, and the game outcomes are reliant upon how the sub-outcomes affect each other.

In one example, game outcomes include three sub-outcomes: (i) a zone outcome, (ii) a symbol outcome, and (iii) a catalyst outcome. The zone outcome defines an activation zone within a plurality of symbol positions, the symbol outcome populates the symbol positions with randomly-selected symbols that may include selectively activated symbols based on the activation zone, and the catalyst outcome determines whether or not an award sequence or other suitable game event occurs based on a catalyst trigger event and any activated symbols occupying the symbol positions.

FIG. 3 depicts an example game interface 100 of a gaming system (e.g., the system shown in FIGS. 1 and 2). The game interface 100 is presented by a presentation assembly in communication with game-logic circuitry to perform the game and presentation functions described herein. The game interface 100 includes a credit meter 102, a bet meter 104, an award meter 106, a symbol array 108, and a plurality of zone indicators 110. In other embodiments, the game interface 100 includes additional, fewer, or alternative game and/or presentation elements, including those described elsewhere herein.

The credit meter 102 indicates a credit balance associated with an active gaming session, where the credit balance funds wagers and collects awards from play of the gaming session. The credit balance may be funded through credit inputs provided external to the gaming session (e.g., physical credit inputs provided to the gaming machine of the gaming system), and initiating a cashout sequence causes the credit balance indicated by the credit meter to be provided to the player of the gaming session. The bet meter 104 indicates a current or last wager within the game, where the wager initiates one or more game outcomes. The award meter 106, similar to the bet meter 104, indicates a current or last award collected within the game. The value indicated by the award meter 106 may be an aggregated award for game outcomes including multiple awards, and the value may persist until the indicated award is applied to the credit balance via the credit meter 102 or the next award is detected.

The system array 108 includes a plurality of symbol positions and a catalyst position 112. The symbol positions are configured to be selectively populated with randomly-selected symbols. The symbols are randomly selected from one or more sets of available symbols, where one or more random value or other random determinations are compared to the sets of available symbols to select the symbols for population. In some embodiments, the sets of available symbols may be symbol-bearing reels strips. Each reel strip is associated with one or more symbol positions (e.g., one column of symbol positions is associated with a reel strip) such that corresponding symbols from the reel strips are exposed within the associated symbol positions based on a reel stop position of the reel strip, which may be selected similar to the symbol selection described above. The symbols and/or reel stop positions may be weighted to affect the probability of the possible selections. In one example, the symbols and/or reel stop positions are stored in a weighted table, where each entry of the table includes a symbol or reel stop position associated with a weight parameter. The weight parameter may be, for example, a range of values that is compared to a randomly generated value. If the randomly generated value is within the range of values, the corresponding symbol or reel stop position is selected. The “weighted” aspect of the weighted table in this example is controlled by varying the size of each range of values, thereby increasing or decreasing the probability of selecting certain symbols or reel stop positions.

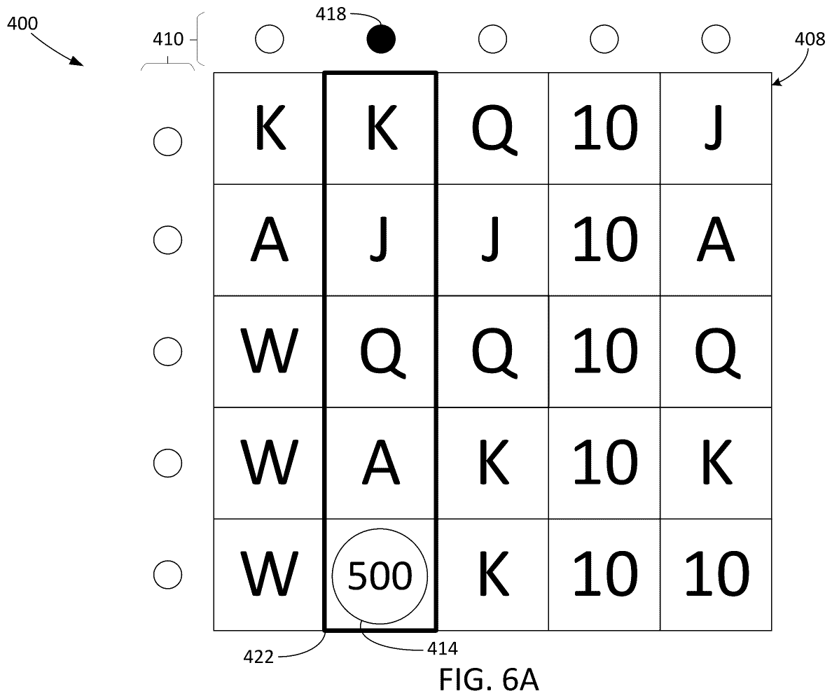

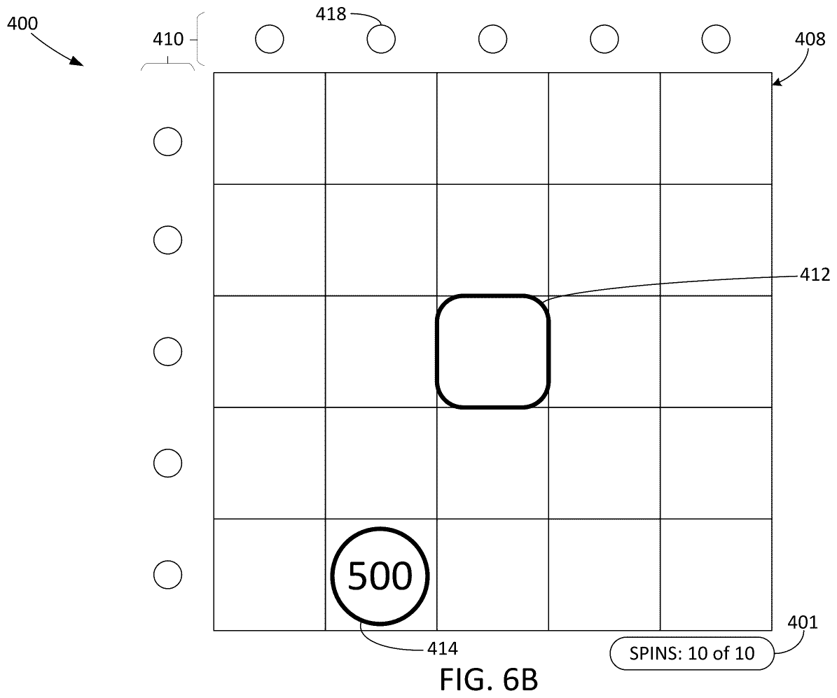

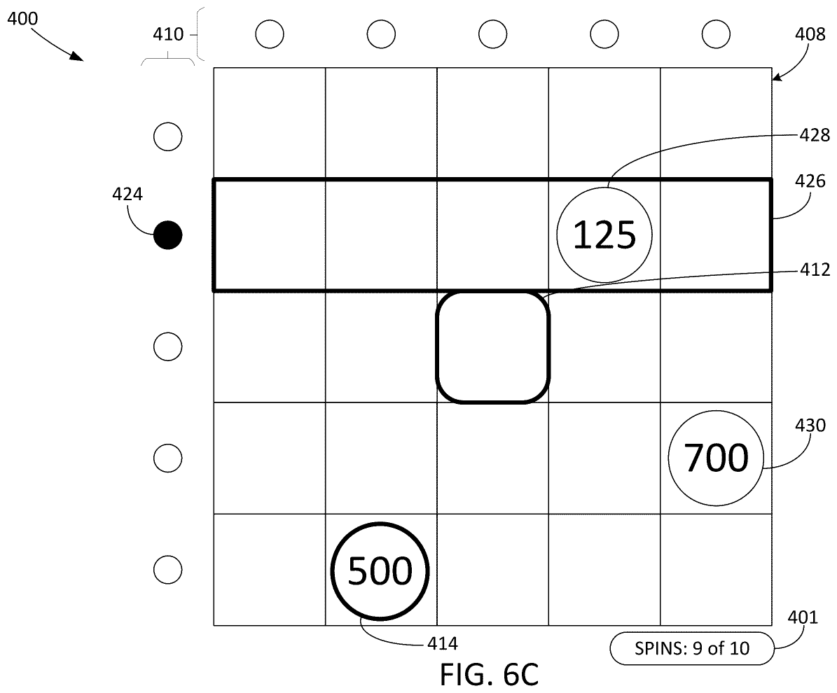

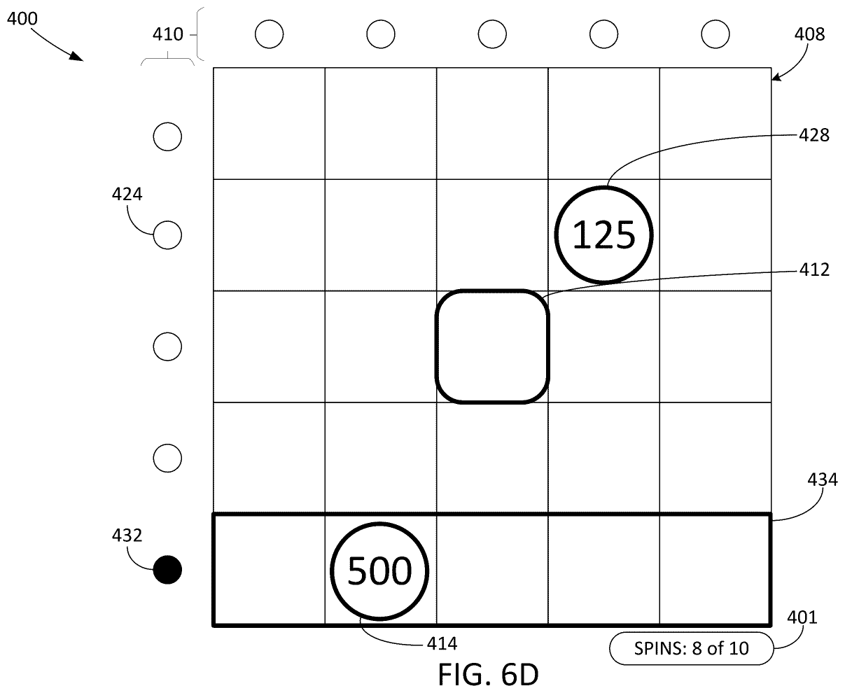

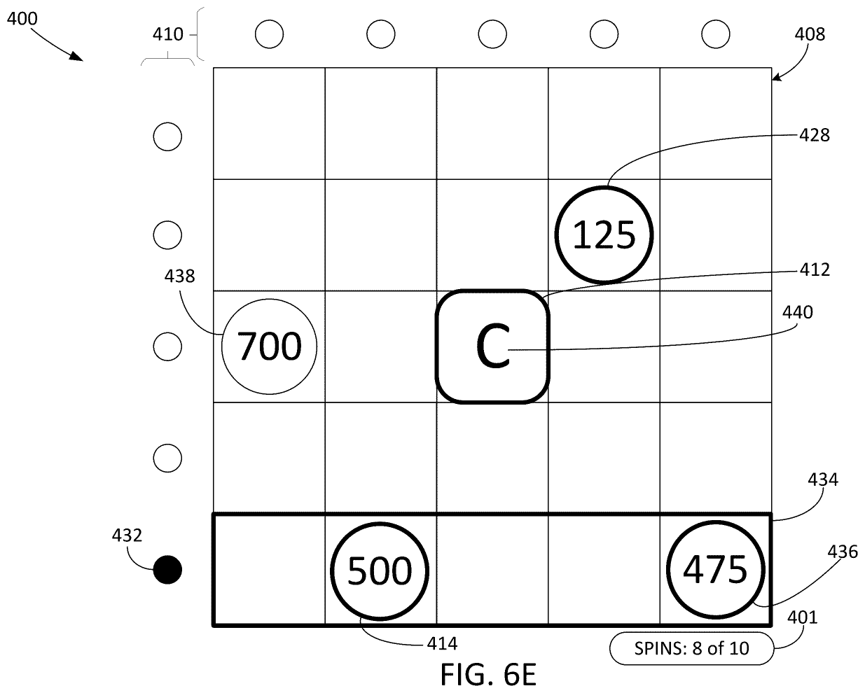

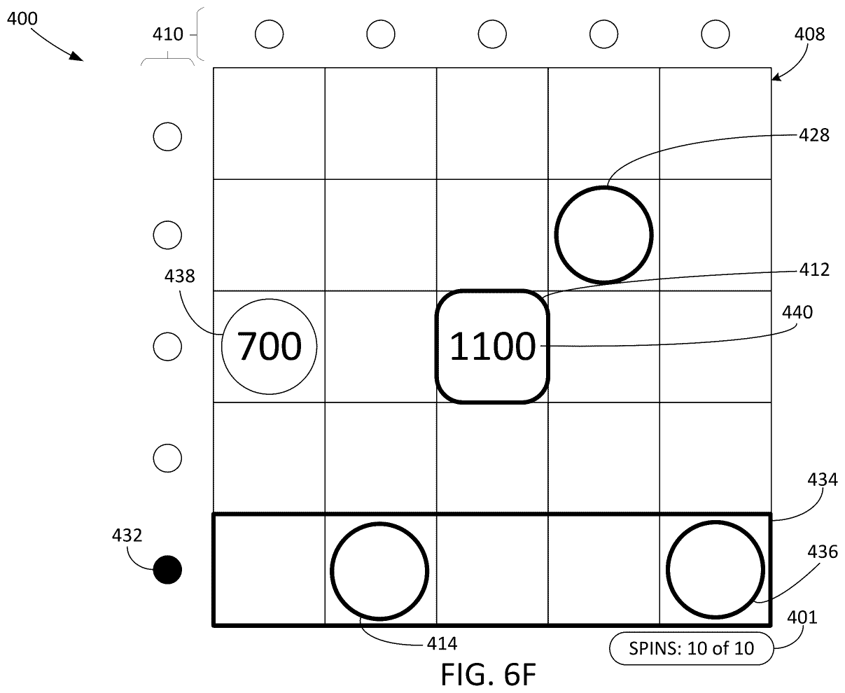

In addition to standard and special symbols (e.g., wilds), the sets of available symbols include one or more value-bearing symbols, such as the value-bearing symbol 114. The value-bearing symbol 114 includes award indicia visually representing an award value associated with the symbol 114. For example, in the illustrated example, the value-bearing symbol 114 has a credit award value of 500. The award value of the value-bearing symbol 114 is selectively awarded in response to certain award conditions, such as those described elsewhere herein. In at least some embodiments, the value-bearing symbols are configured to include different states that affect which game functions are available for the value-bearing symbols. For example, the value-bearing symbols may include an active state and an inactive state, where the active and inactive states are visually distinct from each other. As illustrated herein, active value-bearing symbols are depicted with a bold border (see, e.g., value-bearing symbol 414 shown in FIG. 6B) while inactive value-bearing symbols have a non-bold border like the value-bearing symbol 114. In certain embodiments with games including multiple game stages (e.g., a base game and a feature game), the states of the value-bearing symbol may only be used in a particular game stage.

In the example embodiment, the catalyst position 112 is centrally positioned within the symbol array 108 but is visually distinct from the symbol positions. In some embodiments, the array 108 may include additional catalyst positions 112 and/or the catalyst position 112 at a different location with the array 108. The catalyst position 112 is also selectively populated by symbols but includes at least one distinct symbol unavailable within the other positions. The catalyst position 112 is associated with a catalyst trigger event as described herein. In at least some embodiments, the catalyst trigger event includes detecting the presence or absence of a particular symbol within the catalyst position 112, such as a catalyst symbol. The catalyst symbol may be a symbol unique to the catalyst position 112 or a symbol having enhanced or additional functionality within the catalyst position 112. In other embodiments, the catalyst position 112 is independent from the symbol array 108 (i.e., the catalyst position 112 is visually separate from the array 108).

The zone indicators 110 are configured to determine and visually indicate activation zones within the symbol array 108. Each zone indicator 110 is visually aligned with one or more symbol positions to indicate an association between the indicator 110 and the corresponding subset of symbol positions. In the example embodiment, each zone indicator 110 is aligned with a row or column of the symbol array 108. In other embodiments, other suitable arrangements of zone indicators 110 within the game interface 100 may be used, including different presentation elements representing the indicators 110.

In the example embodiment, the zone indicators 110 are configured to be in an active or inactive state. The state of each zone indicator 110 may be visually indicated via the game interface 100. For example, zone indicator 116 is in an inactive state, while zone indicator 118 is in an active state. The zone indicators 110 are configured to be randomly set in the inactive or active state based on one or more random determinations.

The zone indicators 110 in an active state are configured to identify an activation zone within the plurality of symbol positions. The activation zone as described herein selectively activates value-bearing symbols within the symbol positions associated with active zone indicators 110. In at least some embodiments, multiple zone outcomes may be active or defined in a given game outcome. Activating value-bearing symbols facilitates potential award events that provide an award at least partially based on the award value of active value-bearing symbols.

In the example embodiment, the game associated with the game interface 100 is configured to generate game outcomes through three distinct and interrelated sub-outcomes: (i) a zone outcome, (ii) a symbol outcome, and (iii) a catalyst outcome. More specifically, the zone outcome includes determining the state of each zone indicator 110 which in turn defines one or more activation zones within the symbol positions. The symbol outcome includes populating the symbol positions of the array 108 with randomly selected symbols, where any value-bearing symbols within the activation zone or zones are converted to any active state. The catalyst outcome includes selectively populating the catalyst position 112 with a symbol or blank and determining whether or not a catalyst trigger event is detected (e.g., detecting a catalyst symbol within the catalyst position 112). If the catalyst trigger event is detected, then an award sequence is presented for any active value-bearing symbol, where the award of the award sequence is at least partially a function of the award values indicated by the active value-bearing symbols. These interconnected sub-outcomes are distinctive from each other at least through the use of one or more unique game elements, yet these unique sub-outcomes are interrelated to ultimately result in a single game outcome.

In at least some embodiments, at least a portion of a sub-outcome may persist for multiple game outcomes. In one example, value-bearing symbols that are activated may be configured to lock or persist within the symbol positions for a predetermined number of symbol outcomes. In another example, one zone outcome is performed for a predefined number of game outcomes such that the activation zone persists for multiple symbol outcomes. Other suitable interconnections between the sub-outcomes (including the use of additional, fewer, or alternative sub-outcomes) may be used in other embodiments.

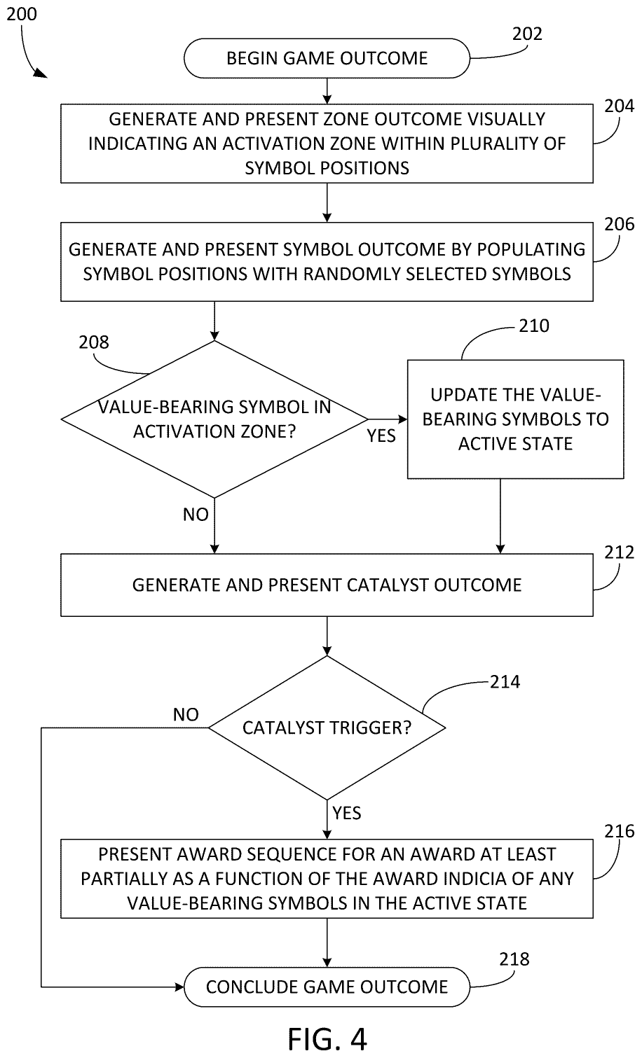

FIG. 4 is a block diagram of an example method 200 for operating a gaming machine of a gaming system (e.g., the system and machine shown in FIGS. 1 and 2). More specifically, the method 200 is associated with a game outcome of a game conducted via the gaming machine and that includes activation zones and catalyst triggers. The method 200 is at least partially performed using game-logic circuitry of the gaming system and a presentation assembly of the gaming machine. In other embodiments, the method 200 includes additional, fewer, or alternative steps and/or is performed using a different suitable configuration of devices, including those steps and devices described elsewhere herein.

The method 200 begins at step 202 for a game outcome process. The game outcome may be initiated in response to a wager, player input, the conclusion of a prior game outcome, and/or other suitable conditions or events associated with the game. In some embodiments, the game outcome is associated with a feature game, where the game outcomes are initiated automatically following a previous game outcome. That is, unlike a base game that requires a wager to initiate each game outcome, the feature game continues without wagers from the player. The feature game may be configured to have a limited duration of game outcomes, which may be defined as a number of game outcomes, a number of detected game events, a period of time, and the like. In one example, the feature game is configured to have a duration of ten game outcomes. The duration of the feature game may be static or dynamic (i.e., the duration is increased or decreased in response to game events detected within the feature game). In other embodiments, the game outcome may be associated with a base game.

In the example embodiment, the game outcome is associated with a plurality of game elements that are presented within a game interface by the presentation assembly. The game interface and game elements may be similar to the interface 100 shown in FIG. 3. That is, the game elements include a plurality of symbol positions and a catalyst position. The game elements may include zone indicators or other suitable presentation elements associated with activation zones as described herein. In other embodiments, the game interface includes additional or alternative game elements. For example, additional features and outcome determinations may be performed in parallel to or in combination with the steps of the method 200 described herein, and game and/or presentation elements may be included within the game interface to facilitate these features and outcome determinations.

Within the game outcome of the step 202, the game-logic circuitry is configured to generate a zone outcome and cause the presentation assembly to present the zone outcome at step 204. More specifically, the zone outcome determines an activation zone within the plurality of symbol positions. The activation zone is presented through visual changes and/or animations to the corresponding symbol positions, such as a highlighted border around the zone, and/or other presentation elements indicate the activation zone (e.g., zone indicators). In at least some embodiments, the activation zone includes less than all of the symbol positions. The determination of the activation zone is at least partially random. For example, the plurality of symbol positions may be organized into position subsets (e.g., rows and columns of a symbol array), and a random determination is performed for each position subset to determine whether or not the position subset is included within the activation zone. In another example, predefined activation zones may be stored in a weighted table, where one or more random values are compared to the weighted table to determine which (if any) activation zone is active. It is to be understood that while the term “activation zone” is used herein, the activation zone may be formed from a plurality of discrete and/or partially overlapping zones defined within the plurality of symbol positions.

In the example embodiment, the activation zone is determined and presented for the current game outcome and is removed from the game interface following the game outcome (i.e., the activation zone does not persist across game outcomes). The removal of the activation zone may be visually indicated by updating the presentation of the symbol positions to remove the visual changes and/or animations associated with the activation zone. In certain embodiments, the activation zone is removed during the step 204 for the next game outcome. In other embodiments, the activation zone may be configured to persist for a plurality of game outcomes. That is, one zone outcome is performed for a plurality of game outcomes, and the step 304 may be skipped or otherwise replaced by a step determining the remaining duration of the activation zone following an initial game outcome including the zone outcome. In certain embodiments, the activation zone may persist and change between game outcomes. For example, the activation zone may be animated via the presentation assembly to include or remove symbol positions between outcomes.

At step 206, a symbol outcome is determined by the game-logic circuitry and is presented by the presentation assembly through changes and animations presented within the game interface. More specifically, the plurality of symbol positions is populated with a plurality of randomly-selected symbols. The randomly-selected symbols are selected from one or more sets of available symbols, which may be symbol-bearing reel strips in at least some embodiments. It is to be understood that the available symbols may include “blanks” that visually appear as the absence of a symbol within a symbol position such that populating the symbol positions may include at least some symbol positions that appear empty for the symbol outcome.

The random selection is performed using one or more random values or determinations performed by the game-logic circuitry, where the random values are compared to values corresponding to the available symbols to select the symbols forming the symbol outcome. The presentation assembly is configured to present a symbol outcome sequence through animations that visually indicate to the player that a new set of symbols populate the symbol positions. In one example where each symbol position is associated with a respective symbol-bearing reel strip, the presentation assembly is configured to present an animation of the reel strips spinning and stopping at the symbols forming the symbol outcome.

Similar to the zone outcome, in some embodiments, the symbol outcome may be configured to persist or partially persist over multiple game outcomes such that the zone outcome and catalyst outcome described herein change between game outcomes, thereby resulting in potentially different awards, game events, and the like between the game outcomes. It is to be understood that partial persistence of the symbol outcome may include holding or locking symbols within the symbol positions for a plurality of game outcomes while other symbol positions are configured to receive new symbols for each symbol outcome.

The available symbols for the symbol outcome include one or more value-bearing symbols or symbols configured to be converted to value-bearing symbols. The value-bearing symbols are symbols that include award indicia that visually represent an award value associated with the respective symbol. Symbols that may be converted to value-bearing symbols include, for example, value-bearing symbols with hidden award indicia or symbols having other functionality within the feature game (or another game stage, such as the base game) that are visually converted into value-bearing symbols. The conversion into the value-bearing symbols may be in response to the steps described herein or a separate determination. For example, the game-logic circuitry may be configured to randomly convert none, one, or a plurality of the symbols from the symbol outcome to value-bearing symbols.

In the example embodiment, the value-bearing symbols are configured to be either active or inactive to facilitate the functionality described herein. The inactive and active states of the value-bearing symbols may be visually distinguished from each other through different visual characteristics and/or animations associated with the value-bearing symbols. In at least some embodiments, the value-bearing symbols initially are in the inactive state and are activated through the steps described herein. In other embodiments, at least some value-bearing symbols may be initially active.

In response to the symbol outcome, the game-logic circuitry is configured to perform one or more outcome determinations. That is, the game-logic circuitry is configured to compare the game state resulting from the symbol outcome (e.g., the symbols populating the symbol positions) to one or more stored, predefined processes to detect any game events or conditions that require subsequent action or changes to the feature game.

For example, at step 208, the game-logic circuitry determines whether or not any value-bearing symbols from the symbol outcome are within the activation zone. The activation zone may be stored by the game-logic circuitry through one or more variables that enables the game-logic circuitry to compare the symbol position occupied by the value-bearing symbol to the symbol positions forming the activation zone. If the symbol position is determined to be within the activation zone, the value-bearing symbol is converted to the active state at step 210 through one or more visual updates and/or animations associated with the value-bearing symbol and presented by the presentation assembly. In some embodiments, the activated value-bearing symbols are configured to persist within the symbol positions for at least one subsequent game outcome. In other embodiments, the activated value-bearing symbols do not persist, and are removed from the symbol positions by the next symbol outcome. In further embodiments, all value-bearing symbols (including inactive value-bearing symbols) are configured to persist for at least one subsequent game outcome. In certain embodiments with persisting value-bearing symbols, preexisting active value-bearing symbols within the activation zone may be configured to extend their respective persistence within the symbol positions in response to the determination at step 208 or may be otherwise unaffected by the activation zone.

Following the step 210 or in response to determining the activation zone does not include value-bearing symbols at the step 208, the method 200 proceeds to step 212. More specifically, the game-logic circuitry is configured to generate a catalyst outcome and the presentation assembly is configured to present the catalyst outcome through one or more suitable visual updates and/or animations to the game interface. In the example embodiment, the catalyst outcome is associated with a catalyst symbol position. The catalyst symbol position is associated with a catalyst set of available symbols. The catalyst set may include, for example, one or more catalyst symbols, blanks (i.e., the absence of a symbol), and/or other suitable symbols that may other or no game functionality within the game outcome. In one example, the catalyst set includes modifier symbols, such as multipliers, that may be applied to the value-bearing symbols and/or other symbols within the symbol positions. The game-logic circuitry, similar to the generation of the symbol outcome, generates one or more random values or determinations to be compared to the catalyst set to determine a symbol or blank to populate the catalyst position. The presentation assembly is configured to animate a corresponding catalyst outcome sequence to visually indicate the catalyst outcome to the player. In other embodiments, the catalyst outcome is associated with additional or alternative game elements. In a first example, the game interface may include multiple catalyst symbol positions, which share the same catalyst set or have respective catalyst sets. In a second example, in place of a catalyst symbol position, a segmented catalyst wheel is used, and the game-logic circuitry is configured to perform a wheel segment selection similar to the symbol population described above.

In response to the catalyst outcome, at step 214, the game-logic circuitry determines whether or not a catalyst trigger event is detected within the catalyst outcome. In the example embodiment, the catalyst trigger event includes the catalyst symbol position being occupied by a catalyst symbol. In other embodiments, additional or alternative game events and/or conditions are included within the catalyst trigger event, including game events and/or conditions external to the catalyst outcome (e.g., within the symbol outcome). In certain embodiments, multiple catalyst trigger events are available, and the game-logic circuitry performs the step 214 for each event. In one example, multiple catalyst symbols are available to populate the catalyst position, where each catalyst symbol is associated with a respective modifier applied to one or more symbols or awards as described herein.

If a catalyst trigger event is detected at the step 214, the game-logic circuitry causes the presentation assembly to present an award sequence at step 216 for an award at least partially as a function of the award values indicated by any active value-bearing symbols occupying the symbol positions. In one example, the award is an aggregate award that is formed by adding the award values of the active value-bearing symbols together. In other embodiments, other suitable mathematical and/or logical operations may be used to determine the award. The presentation assembly is configured to animate, visually update, and otherwise indicate to the player the presence of the award. In at least some embodiments, the award sequence includes one or more meters (e.g., the credit meter 102 and/or the award meter 106, both shown in FIG. 3) being animated to include the value of the award.

As a result, the award sequence of the step 216 is the culmination of three sub-outcomes of the game outcome: (i) the activation zone from the zone outcome, (ii) the value-bearing symbols populating the symbol positions, and (iii) the catalyst trigger event, where these sub-outcomes interact with each other by the activation zone selectively activating value-bearing symbols and the catalyst trigger event resulting in an award associated with any active value-bearing symbols. Each sub-outcome is distinct from the others at least through the use of different game elements and different outcome determinations. The use of different game elements and the visual relationships between the game elements facilitate a game presentation that readily conveys the interconnection between the sub-outcomes and enables the sub-outcomes to be presented simultaneously or substantially overlapping. That is, the zone outcome, symbol outcome, and the catalyst outcome may be presented together, at least partially overlapping, or in a different order relative to the steps of the method 200 (e.g., the catalyst outcome is presented prior to the symbol outcome or zone outcome). In certain embodiments, the sub-outcome determinations may share underlying resources of the game-logic circuitry to provide enhanced efficiency of the game outcome processing. For example, random values or determinations may be generated by the game-logic circuitry and shared between different sub-outcomes, where the random values have different effects within the context of each sub-outcome.

Following the step 216 or in response to determining no catalyst trigger event from the catalyst outcome, the game outcome concludes at step 218. The subsequent game outcomes may be provided by repeating the steps of the method 200 until a termination condition is detected (e.g., the duration of the feature game has expired or a cashout sequence is initiated), which concludes the game and/or the gaming session at the gaming machine.

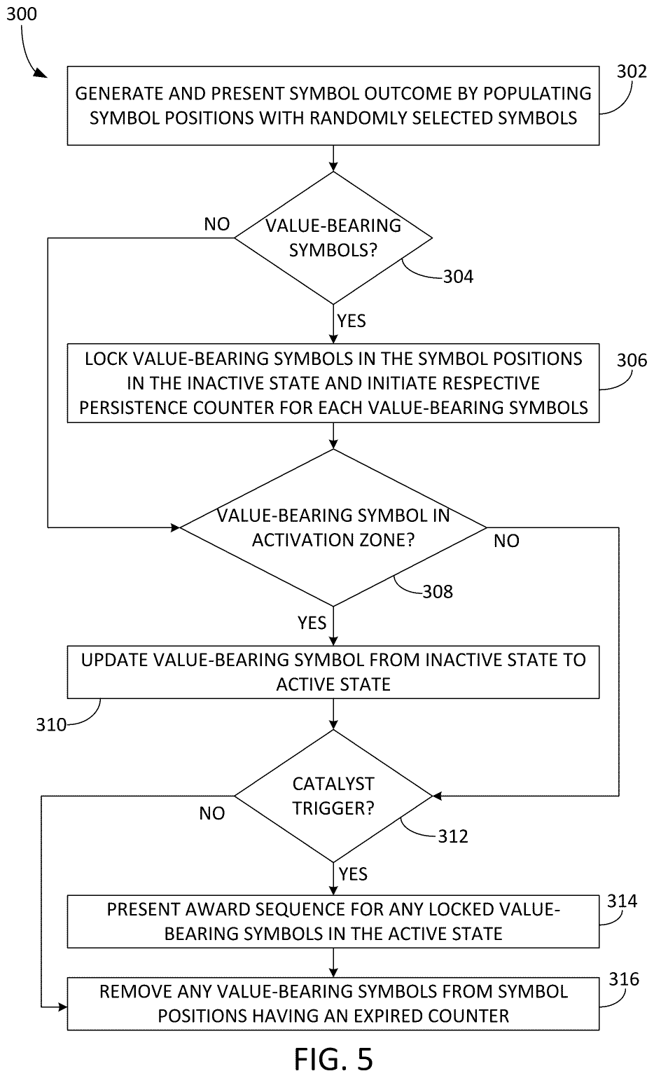

FIG. 5 depicts an example method 300 of operating a gaming machine of a gaming system. In particular, the gaming machine is configured to conduct a feature game including activation zones, catalyst triggers, and persistent value-bearing symbols. The method 300 may be similar to the method 200 shown in FIG. 4 unless otherwise specified. The method 300 is performed using game-logic circuitry of the gaming system in communication with a presentation assembly of the gaming machine. The method 300 is associated with a game interface presented by the presentation assembly, and the game interface includes a plurality of symbol positions and a catalyst position. The symbol positions selectively include one or more activation zones, which may be defined through a zone outcome or other suitable game event (e.g., symbols from a previous symbol outcome) and/or random determination. In other embodiments, the method 300 includes additional, fewer, or alternative steps, including those described elsewhere herein. For example, the method 300 may be adjusted for use with different game elements than the game elements described above.

At step 302, the game-logic circuitry generates a symbol outcome by randomly selecting (e.g., via generating one or more random values and comparing the random values to one or more sets of available symbols) symbols to populating a plurality of symbol positions. The presentation assembly is configured to present the symbol outcome through one or more animations and other visual changes to the presentation and/or game elements presented within the game interface. For example, the sets of available symbols may be cycled, spun, or otherwise animated to selectively appear within the associated one or more symbol positions such that the animation stops, pauses, or finishes with the symbols forming the symbol outcome within the symbol positions.

In response to the symbol outcome being generated, the game-logic circuitry performs one or more outcome determinations. For example, one outcome determination includes detecting whether or not winning symbol combinations are present within the symbol outcome. Another example outcome determination includes detecting the presence or absence of a particular trigger symbol within the symbol outcome. In the example embodiment, at step 304, the game-logic circuitry is configured to perform an outcome determination for detecting any new value-bearing symbols within the symbol outcome. It is to be understood that “new” value-bearing symbols are symbols originating from the symbol outcome in the step 302, and that at least some value-bearing symbols may be retained from prior symbol outcomes. That is, at least some value-bearing symbols may be configured to be locked, held, or otherwise persist within the symbol positions for a plurality of symbol outcomes. The locked value-bearing symbol prevents other symbols from occupying the corresponding symbol position. More specifically, the game-logic circuitry may not select a new symbol for the locked symbol position, or the locked value-bearing symbol may supersede any selected symbol for the locked symbol position such that the selected symbol is visually hidden and ignored for any outcome determinations. In certain embodiments, the locked value-bearing symbol may be configured to facilitate co-occupation of a symbol position with another symbol such that all symbol positions are configured to receive new symbols for a given symbol outcome.

If no new value-bearing symbols are detected within the symbol outcome, the game-logic circuitry proceeds within any remaining outcome determinations (e.g., step 308 described herein). However, if at least one new value-bearing symbol is detected, the game-logic circuitry is configured to lock the new value-bearing symbols within the symbol positions at step 306. In at least some embodiments, each of the value-bearing symbols are locked within the respective symbol position occupied by the value-bearing symbol during the symbol outcome. Locking a value-bearing symbol may be visually conveyed via the game interface of the presentation assembly through one or more visual changes and/or animations associated with the new value-bearing symbol.

In the example embodiment, the value-bearing symbols are locked in an inactive state. The inactive value-bearing symbols are ignored or otherwise bypassed for an award sequence described herein. In at least some embodiments, based on the steps below, one or more value-bearing symbols may be immediately converted into or otherwise initially set to an active state. In certain embodiments, each value-bearing symbol may be initially locked into an inactive or active state based at least partially on a random determination. The active and inactive states of the value-bearing symbols are presented through visually distinct characteristics of the presentation elements associated with the value-bearing symbols (e.g., the symbols and/or the occupied symbol position), and the transition between the active and inactive states may be visually conveyed through one or more suitable animations associated with the value-bearing symbols.

In the example embodiment, the locked value-bearing symbols are configured to persist for at least one additional symbol outcome. The game-logic circuitry is configured to initiate a persistence counter for each of the locked value-bearing symbols to monitor the remaining duration of the value-bearing symbols. In some embodiments, each value-bearing symbol is associated with a respective persistence counter. In other embodiments, each group of value-bearing symbols having a common remaining duration (e.g., all value-bearing symbols locked on the same symbol outcome share may share a common duration) are associated with a single persistent counter. In further embodiments, a single persistence counter is shared by all locked value-bearing symbols within the symbol positions.

The persistence counter is configured to be initiated at a predetermined initial value and updated through the game towards a termination count. In the example embodiment, the persistence counter is updated in response to each symbol outcome. In other embodiments, the persistence counter is updated in response to other suitable game events, such as symbol outcomes that do not include any new value-bearing symbols. In certain embodiments, the duration of the persistence counter is dynamic such that the duration may be extended, reduced, or selected from a plurality of available durations. In one example, the duration of the persistence counter is extended or reset in response to detecting new value-bearing symbols within a symbol outcome. In another example, an award sequence as described herein may cause the duration to be set to the termination count. In a further example, the duration of each value-bearing symbol may be randomly set to persist for one, two, or three subsequent symbol outcomes.

In some embodiments, the persistence counter is hidden from the game interface (i.e., the counter is a variable stored by the game-logic circuitry without presentation). In such embodiments, the value-bearing symbols may be configured to change in appearance as the current count of the persistence counter changes. For example, the color of the value-bearing symbol may change in response to the current count approaching the termination count. In another example, an animation associated with the value-bearing symbol (e.g., an animated border of the value-bearing symbol) changes based on the current count. In other embodiments, the persistence counter is presented by the presentation assembly within the game interface to enable the player to visually monitor the duration of each locked value-bearing symbol. In these embodiments, the presentation of the persistence counter, the locked value-bearing symbols, and/or the locked symbol positions may change in response to changes to the current count and/or the remaining duration of the locked symbols.

Although steps 304 and 306 are directed to value-bearing symbols, it is to be understood that other suitable symbol types may be selectively locked within the symbol positions. For example, modifier symbols that are associated with a modifier (e.g., a multiplier) or jackpot trigger symbols may be selectively locked within the symbol positions. The locked symbols may be integrated within the award sequence described herein, may share the same collection trigger (but are not awarded within the same award sequence), or may be collected and/or awarded through game events and/or conditions separate from the steps of the method 300 described herein. In one example, the modifier of the modifier symbol may be applied to the award sequence similar to the award values of the value-bearing symbols. In another example, jackpot trigger symbols may be held within the symbol positions, and a progressive jackpot is awarded in response to at least a threshold number of jackpot trigger symbols occupying the symbol positions irrespective of the activation zone described herein. Accordingly, the steps of the method 300 as described herein may be applied to other lockable symbol types and adjusted according to the functionality associated with said symbol types.

At step 308, the game-logic circuitry determines whether or not any value-bearing symbols are within an activation zone. The activation zone is a subset of the plurality of symbol positions that is visually distinguished from the remaining symbol positions. The activation zone is determined separately from the symbol outcome, such as through a zone outcome that randomly determines the location, size, and/or shape of the activation zone for one or more symbol outcomes. In certain embodiments, while the activation zone and symbol outcome are generated separately, the presentation and animations associated with the activation zone and the symbol outcome may be blended or synchronized together to appear at least partially unified within a single game outcome. In other embodiments, the activation zone is determined via the symbol outcomes, where the symbols populating the symbol positions include one or more zone indicators that the game-logic circuitry detects to form the activation zone. In one example, detecting a zone indicator (which may be a particular symbol type within the symbol outcome) in a particular row or column causes the activation zone to include the symbol positions within the row or column.

If no value-bearing symbols populate the activation zone, the game-logic circuitry proceeds to other sub-outcomes and/or outcome determinations. However, if a value-bearing symbol is within the activation zone, the method 300 proceeds to step 310. At step 310, the one or more value-bearing symbols within the activation zone are updated from the inactive state to the active state. The state transition is visually indicated through one or more visual changes and/or animations associated with the value-bearing symbol. For any previously active value-bearing symbols within the activation zone, the step 310 may be ignored or the associated persistence counter is reset or otherwise altered to increase the remaining duration of the active value-bearing symbol. In certain embodiments, the persistence counters of the updated value-bearing symbols (i.e., updated from the inactive state to the active state) are also reset or changed in response to the step 310.

In the example embodiment, through steps 304-310, any value-bearing symbols from the symbol outcome are locked into the symbol array initially in an inactive state, and the activation zone is used to convert locked value-bearing symbols from the inactive state to the active state for the steps of the method 300 described herein. In other embodiments, value-bearing symbols are not automatically locked into the symbol positions. Rather, only active value-bearing symbols may be configured to persist for at least one subsequent game outcome, and any value-bearing symbols that remain in the inactive state are removed for the next symbol outcome. That is, in such embodiments and in comparison to the illustrated method 300, the outcome determination at step 304 is removed, and the determination at the step 308 is performed prior to the steps 306 and 310, where the steps 306 and 310 are performed for the value-bearing symbols within the activation zone.

Following steps 308 and 310, the game-logic circuitry is configured to determine whether or not a catalyst trigger event is present within the game outcome at step 312. In some embodiments, the catalyst trigger event is detected within a catalyst outcome separate from the symbol outcome. In one example, one or more catalyst symbol positions are selectively populated with catalyst symbols, and the catalyst trigger event includes detecting at least a threshold number (e.g., one, two, or three) of catalyst symbols within the catalyst outcome or over a plurality of catalyst outcomes. In another example, other suitable catalyst game elements are presented within the game interface, and the catalyst game outcome is presented in a suitable manner associated with the particular catalyst game element that visually conveys at least the presence or absence of a catalyst trigger event. In other embodiments, the catalyst trigger event occurs within the symbol outcome. In one example, the catalyst symbols are present within the sets of available symbols. In another example, certain predefined combinations of symbols within the symbol outcome represent the catalyst trigger event.

If a catalyst trigger event is detected, the game-logic circuitry proceeds to step 314. More specifically, at step 314, the game-logic circuitry causes the presentation assembly to present an award sequence based on the active value-bearing symbols occupying the symbol positions in response to the catalyst trigger event. The award sequence is a presentation sequence including one or more presentation elements, visual updates, and/or animations that visually convey to the player the presence of an award that is to be applied to a credit balance of the player. For example, one or more meters monitoring the credit balance and/or an award total may be configured to update within the award sequence to reflect the award. In at least some embodiments, the award is an aggregation of the award values visibly indicated by the value-bearing symbols. In such embodiments, the award sequence may include animations visibly indicating the aggregation (e.g., removing the award indicia from each active value-bearing symbol and updating a corresponding meter to include the award value). In other embodiments, other suitable mathematical and/or logical operations are performed such that the award associated with the award sequence is at least partially a function of the award values visibly indicated by the active value-bearing symbols. It is to be understood that the award sequence described with respect to the step 314 may be combined with other award sequences (e.g., a winning symbol combination is detected within the same symbol outcome) to facilitate a unified game presentation.

In some embodiments, the active value-bearing symbols may be removed or otherwise configured to expire in response to the award sequence. In other embodiments, the active value-bearing symbols are configured to remain locked within the symbol positions such that award sequences of subsequent game outcomes including the catalyst trigger event may be based on the same locked value-bearing symbols. In certain embodiments, the active value-bearing symbols may be set to an inactive state at the beginning of the next symbol outcome such that the value-bearing symbols need to be within a subsequent activation zone to persist and be included within subsequent award sequences.

Following step 314 or step 312 if no catalyst trigger event is detected, the game-logic circuitry is configured to remove any locked value-bearing symbols having expired persistence counters (i.e., counters indicating no remaining duration is left for the symbol) at step 316. The counters may be updated before, during, or after the symbol outcome generation and/or presentation. In some embodiments, the expired value-bearing symbols are removed as part of the next symbol outcome presentation sequence (e.g., the spinning and stopping of symbol-bearing reels) similar to other symbols. In other embodiments, the expired value-bearing symbols are removed from the symbol positions through a separate removal sequence.

The method 300 is configured to repeat over a plurality of game outcomes, which may include multiple sub-outcomes in at least some embodiments. The activation zone, symbol outcome, and/or catalyst trigger event may be configured to persist for a plurality of game outcomes such that at least some of the game elements described above change between the game outcomes, thereby resulting in different interactions between the game elements and corresponding outcome determinations (e.g., whether or not to initiate an award sequence).

FIGS. 6A-6F depict an example game interface 400 for a game conducted by a gaming system (e.g., the gaming system shown in FIGS. 1 and 2). The game interface 400 is presented by a presentation assembly of a gaming machine. The presentation assembly is in communication with game-logic circuitry (which may be independent from, partially integrated with, or wholly integrated within the gaming machine) to perform the functionality described herein. FIGS. 6A-6F depict the game interface 400 within a plurality of states representing different features, events, and conditions associated with the presentation and underlying game. In other embodiments, the game interface 400 includes additional, fewer, or alternative game and/or presentation elements, including those elements described elsewhere herein.

FIG. 6A depicts the game interface in a first state depicting an outcome of a base game including a feature game trigger event. The game interface 400 in the first state includes a symbol array 408 and a plurality of zone indicators 410. The symbol array 408 includes a plurality of symbol positions arranged into rows and columns, and the symbol positions are populated with randomly-selected symbols through the base game outcome. In some embodiments, the symbol array 408 may include additional or fewer symbol positions and/or a different configuration of the symbol positions, such as configurations having multiple independent arrays.

In the example embodiment, during the base game, the symbol array 408 only includes symbol positions. In other embodiments, the symbol array 408 may include other suitable game elements, such as one or more catalyst positions. Within the base game, combinations of symbols populating the symbol array 408 are analyzed by the game-logic circuitry to determine whether or not any winning symbol combination and/or other game event is present within the base game outcome.

In addition to symbol combinations, other game events may be based on one symbol and/or other game elements present within the game interface 400. For example, a feature game may be triggered based on value-bearing symbols and activation zones present within the game interface 400. In the example embodiment, the symbols from the base game outcome include a value-bearing symbol 414 that may be used to trigger the feature game as described herein. In at least some embodiments, the value-bearing symbol 414 may include additional functionality within the base game. For example, the value-bearing symbol 414 may be configured to be included within winning symbol combinations, function as other special symbol types (e.g., a wild symbol, depicted as a ‘W’ in FIG. 6A), and/or the like.

In the example embodiment, in addition to the randomly-selected symbols populating the symbol array 408, the game-logic circuitry is configured to generate an activation zone 422 for each base game outcome. In the example embodiment, the game-logic circuitry is configured to select one or more columns and/or rows of the symbol array 408 to be defined as one or more activation zones. In other embodiments, the activation zones may be defined in other subsets of the symbol array 408, including those described elsewhere herein.

To present the activation zone, the presentation assembly is configured to animate the zone indicators 410 to visually indicate the activation zone 422, and the activation zone 422 may also be visually indicated through visual changes and/or animations applied to the symbol positions defining the zone 422 (e.g., the bold border shown in FIG. 6A). In the example embodiment, the zone indicators 410 are configured to be selectively presented in an inactive state or active state, where zone indicators 410 in the active state are associated with an activation zone. In the first state, a first zone indicator 418 is in the active state, which indicates the corresponding column of the symbol array 408 is defined as the activation zone 422. In some embodiments, the presentation assembly is configured to animate the zone indicators to cycle between the inactive and active states before landing or stopping a final state for the base game outcome. This zone indicator sequence may occur before, during, and/or after the symbol outcome sequence for presenting the symbols populating the symbol array 408.

In the example embodiment, the feature game trigger event includes the value-bearing symbol 414 occupying the activation zone 422. That is, one or more value-bearing symbols occupying the activation zone 422 triggers the feature game. Additionally or alternatively, other suitable feature game trigger events are available. In one example, a different threshold number of value-bearing symbols triggers the feature game. In another example, a different symbol type (including symbols that can be converted to value-bearing symbols within the feature game) within the activation zone triggers the feature game.

FIG. 6B depicts the game interface 400 in a second state following the first state. The second state is the transition from the base game to the feature game in response to the feature game trigger event from the first state. The presentation assembly is configured to present one or more additional or altered presentation elements, visual changes, and/or animations the visually convey to the player the game transition and any new or enhanced game elements for use within the feature game.

In the example embodiment, the symbols from the first state are removed from the array 408 with the exception of the symbol or symbols associated with the feature game trigger event (i.e., the value-bearing symbol 414). Similarly, the activation zone 422 from the first state has been removed, and the corresponding zone indicator 418 has been updated to the inactive state. In some embodiments, the symbols and/or the activation zone 422 are not removed from the array 408 during the transition to the feature game. In one example, the symbols and/or the activation zone 422 may be removed during the presentation of the first feature game outcome. In another example, the symbols unassociated with the feature game may be presented in an inactive state (e.g., greyed-out, semi-transparent, etc.) through the feature game. In certain embodiments, the activation zone 422 may be configured to persist for one or more subsequent feature game outcomes. In at least some embodiments, the sets of available symbols between the base game and the feature game are different, and the transition to the feature game may include visual indication that the symbols of the base game are not present in the feature game (e.g., the removal of the symbols). In the illustrated embodiments, the presented symbols for each feature game outcome are limited to the symbols associated with the game functions described herein for clarity purposes. However, it is to be understood that other suitable symbols may be included within the symbol outcomes of the feature game, including symbols that may result in awards, enhancements, and/or other suitable game events associated with the feature game. In one example, line pays and/or scatter pays based on symbol combinations may be present within the feature game.

In the example embodiment, any value-bearing symbols or other trigger symbols that are convertible to value-bearing symbols are initially locked into the symbol array 408 in an active state. In some embodiments, the value-bearing symbol 414 does not include award indicia during the base game, but instead the award indicia is revealed through the transition to the feature game. In some embodiments, the feature game may be initiated with an award sequence for the trigger symbols irrespective of any catalyst trigger event such that at least one award sequence is guaranteed for a feature game.

The value-bearing symbol 414 is locked within the symbol position occupied by the value-bearing symbol 414 during the first state. In other embodiments, locked symbols may be configured to be moved or arranged to facilitate certain game functions and/or presentations. In one example, the value-bearing symbols are locked in the lowest, highest, rightmost, or leftmost available symbol position of a given column or row. In such an example, a column or row filled with locked symbols may be removed from the selection process for generation new activation zones.

In addition to locking the value-bearing symbol 414, the transition to the feature game includes presenting a catalyst symbol position 412. In the example embodiment, the catalyst symbol position 412 is presented within the symbol array 408. Although the catalyst symbol position 412 is illustrated to be within the middle or center of the array 408, it is to be understood that the catalyst symbol position 412 may be any other position within the array 408, include additional symbol positions added for the feature game. In certain embodiments, the catalyst symbol position is configured to “move” between positions within the symbol array 408 during the feature game. In other embodiments, the catalyst symbol position 412 may be separate from the symbol array 408 altogether. Additionally or alternatively, the feature game may include a plurality of catalyst symbol positions 412.

In the example embodiment, the feature game has a limited duration. The duration may be defined by a number of feature game outcomes, a time period, and/or a number of other suitable game events occurring (e.g., the presence or absence of certain symbols within the feature game outcomes). The duration may be predefined (e.g., ten feature game outcomes), or the duration may be dynamic such that certain game events and/or conditions of the feature game reduce or increase the remaining duration of the feature game. In one example, certain awards, such as jackpot progressive awards, that are triggered within the feature game may cause the feature game to automatically conclude. In another example, each feature game outcome with new value-bearing symbols extends the duration of the feature by at least one additional outcome.

In the example embodiment, to enable the player to visually monitor the duration of the feature game, the game interface 400 includes a duration counter 401, which is configured to progress from an initial value to a termination counter. In the illustrated embodiment, the counter 401 is configured to be decreased from an initial value of ten to a termination count of zero, where the counter 401 is decremented in response to each feature game outcome. In other embodiments, the initial value, termination count or value, and/or the means of progression (e.g., incrementing, decrementing, etc.) may be adjusted to suit the particular theme and game configuration.

FIG. 6C depicts the game interface 400 in a third state following the second state. In the third state, an initial feature game outcome is being presented. In particular, the feature game outcome includes three sub-outcomes being shown: (i) a zone outcome, (ii) a symbol outcome, and (iii) catalyst outcome. In the zone outcome, a new activation zone has been randomly selected and is presented as activation zone 426 (and the corresponding zone indicator 424 in the active state). The symbol outcome, which includes randomly selecting symbols to populate the symbol positions of the symbol array 408, includes the locked value-bearing symbol 414 and two new value-bearing symbols 428, 430. The new value-bearing symbols 428, 430 are initially in an inactive state. However, the first new value-bearing symbol 428 occupies the activation zone 426, while the second new value-bearing symbol 430 is external to the activation zone 426. As a result (and shown in and described with respect to FIG. 6D herein), the first new value-bearing symbol 428 is set to an active state and locked within the symbol array 408, while the second new value-bearing symbol is removed for the symbol outcome of the next feature game outcome. In certain embodiments, both of the new value-bearing symbols, irrespective of active or inactive states, may be held for one or more subsequent game outcomes. In such embodiments, the difference between active and inactive value-bearing symbols may include duration and/or which symbols are associated with an award process as described herein.

Each held or locked value-bearing symbol is associated with a corresponding persistence counter (not shown). The persistence counter indicates the remaining duration of the value-bearing symbol, where value-bearing symbols associated with expired durations are removed from the symbol array 408. In the example embodiment, the value-bearing symbols are configured to be held for at least two subsequent feature game outcomes. In other examples, the value-bearing symbols are held for one subsequent game outcome in response to being locked into the array 408.

The catalyst outcome is associated with the catalyst symbol position 412. That is, similar to the symbol population of the symbol outcome, the catalyst symbol position 412 is selectively populated with symbols and/or blanks. In the third state, the catalyst outcome includes a blank occupying the catalyst symbol position 412. Accordingly, no catalyst trigger event is detected from the catalyst outcome.

Each of the zone outcome, symbol outcome, and the catalyst outcome are depicted through changes to the game interface 400, which may include animations (e.g., spinning reels, cycling possible outcomes, etc.) that delineate between consecutive outcomes and visually convey an underlying selection process is occurring or has occurred. Additionally or alternatively, the visual changes to the game interface 400 and animations are configured to highlight or visually convey certain game events or conditions, such as winning outcomes, trigger events, and the like. For example, the duration counter 401 is configured to be updated by the presentation assembly to convey the new current count, which was decremented in response to the feature game outcome. The animations, new presentation elements, and/or changes to the preexisting presentation elements are configured based on the theme and configuration of the feature game and the gaming machine.

FIG. 6D depicts the game interface 400 in a fourth state following the third state. In particular, the fourth state includes a zone outcome of a subsequent feature game outcome following the feature game outcome associated with the third state. In the new zone outcome, the prior activation zone 426 is removed and a zone indicator 432 is activated to indicate a new activation zone 434. The new activation zone 432 includes the previously held value-bearing symbol 414. In the example embodiment, the duration of the value-bearing symbol 414 is extended in response to occupying a new activation zone. In other embodiments, the activation zone 434 does not impact the duration of the value-bearing symbol 414 (i.e., the duration is predefined and static).

In addition to the new activation zone 434, the fourth state depicts the difference between the new value-bearing symbols 428, 430 shown in the third state. In particular, the first new value-bearing symbol is locked into the symbol array 408 in the active state (illustrated by the bold border of the symbol 428), while the inactive second value-bearing symbol 430 was removed in the fourth state from the array 408. In some embodiments, the removal of the second value-bearing symbol 430 occurs during the presentation of the subsequent symbol outcome.

FIG. 6E depicts a fifth state following the fourth state. More specifically, the fifth state depicts the remaining two sub-outcomes of the feature game outcome associated with the fourth state. That is, the feature game outcome includes the zone outcome depicted in the fourth state and the symbol and catalyst outcomes of the fifth state. In the symbol outcome of the fifth state, in addition to the two previously held value-bearing symbols 414, 428, two new value-bearing symbols 436, 438 occupy the symbol array 408. The first new value-bearing symbol 436 occupies the activation zone 434. As a result, the first new value-bearing symbol 436 is converted to the active state and locked into the array 408. The second value-bearing symbol 438 landed outside of the activation zone 434, and therefore remains inactive.

The catalyst outcome shown in fifth state includes a catalyst symbol 440 occupying the catalyst symbol position. The catalyst symbol 440 is associated with a catalyst trigger event. In the example embodiment, detecting a catalyst trigger event causes the presentation assembly to present an award at least partially as a function of any active value-bearing symbols within the symbol array 408. In other embodiments, the award sequence further includes all value-bearing symbols within the symbol array 408 for the feature game outcome including the catalyst trigger event, including inactive value-bearing symbols (e.g., the second new value-bearing symbol 438). In certain embodiments, the award sequence is presented for an award associated with a subset of the active value-bearing symbols, where one or more active value-bearing symbols are selected for the award such that unselected symbols are not associated with the award. In the illustrated embodiment, the award is an aggregation of the values visibly indicated by the active value-bearing symbols 414, 428, and 436. In other embodiments, the award may be functionally determined through additional or alternative mathematical operations. In one example, the symbols may include modifiers that multiply, enhance, or otherwise adjust the award based on predetermined criteria.

FIG. 6F depicts the game interface 400 in a sixth state following the fifth state, where the sixth state is associated with the award sequence resulting from the catalyst trigger event detected in the fifth state. In particular, the values from the active value-bearing symbols 414, 428, and 436 have been aggregated and are presented within the catalyst symbol position 412 (which may replace the catalyst symbol 440 or be presented over the symbol 440 as award indicia). The award indicia of the catalyst symbol position may be configured to dynamically update within the award sequence, where each value from the value-bearing symbols 414, 428, and 436 is collected and aggregated together sequentially. The aggregation may be supplemented by removing or changing the award indicia and/or the value-bearing symbols 414, 428, and 436 as a whole to indicate the origin of each value composing the award. In the example embodiment, the award indicia is removed from the value-bearing symbols 414, 428, and 436. In other embodiments, other suitable animations and/or changes to the game interface 400 may be used to facilitate the presentation of the award. In one example, in addition to or in place of the catalyst symbol position 412, the award indicia may be indicated by one or more meters present on the game interface 400 (e.g., a credit or award meter) that are animated to change in response to the award sequence.

In the example embodiment, the detection of an award sequence is a reset condition for the duration counter 401. That is, the current count of the duration counter 401 is reset to the initial value or another suitable reset value in response to the award sequence. In other embodiments, the duration counter is unaffected by the award sequence and continues to progress towards the termination count.

The feature game is configured to continue with subsequent feature game outcomes until the duration counter 401 reaches the termination count and/or other termination conditions are detected. In response to detecting the termination condition, the feature game concludes, and the game interface 400 is configured to transition to the base game or another game component of the current gaming session. The transition sequence may include, without limitation, animations, summaries of the feature game, award sequences (e.g., awards may be aggregated by an award meter throughout the feature game, and the termination award sequence may update the credit meter to include the aggregate value from the award meter), visual changes to the game and/or presentation elements, and/or the addition and/or removal of game elements.

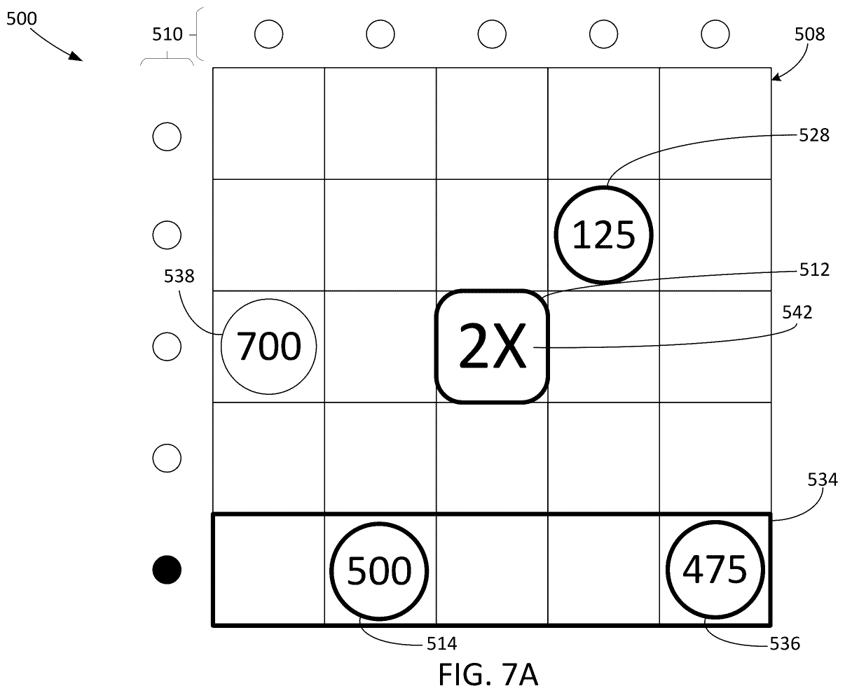

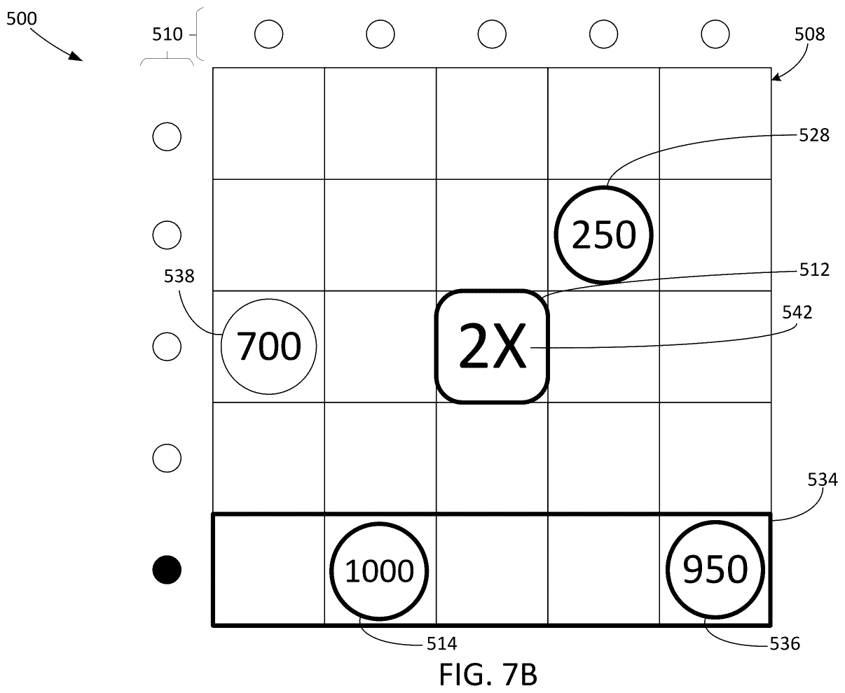

FIGS. 7A and 7B depict a game interface 500 using a multiplier catalyst outcome. The game interface 500 is presented by a presentation assembly of a gaming machine, and the interface 500 may be similar to the game interface 400 shown in FIGS. 6A-6F (particularly the fifth state shown in FIG. 6E) unless otherwise specified. For example, the game interface 500 includes a symbol array 508 and a plurality of zone indicators 510. The symbol array 508 includes a plurality of symbol positions and catalyst position 512. Within the symbol array 508, an activation zone 534 and a plurality of value-bearing symbols 514, 528, 536, and 538 are shown. Three of the four value-bearing symbols 514, 528, and 536 are in an active state, while the fourth value-bearing symbol 438 is in the inactive state. In other embodiments, the game interface 500 includes additional, fewer, or alternative game and/or presentation elements, including those described elsewhere herein.

FIG. 7A depicts the game interface 500 in a first state. In the first state, the game interface 500 includes a catalyst outcome including a multiplier symbol 542 within the catalyst symbol position 512. The multiplier symbol 542 includes indicia visibly indicating a corresponding multiplier to be applied to the value-bearing symbols as described herein. Additionally or alternatively, other modifier symbols (including symbols associated with modifiers untethered to the value-bearing symbols, such as reset symbols for duration counters, jackpot trigger symbols, and the like) may be included within the set of available symbols for the catalyst symbol position. In some embodiments, the multiplier symbol 542 is a catalyst symbol and is associated with a catalyst trigger event. In other embodiments, the multiplier symbol 542 is not associated with a catalyst trigger event such that a catalyst trigger event must be detected in subsequent catalyst outcomes (or from other catalyst positions in embodiments with multiple catalyst positions). In certain embodiments, the multiplier symbol 542 occupies other types of symbol positions, such as the symbol positions of the symbol array 508 and/or other dedicated modifier symbol positions.

In the illustrated embodiment, the multiplier associated with the multiplier symbol is a 2× multiplier, which doubles one or more award values. In the example embodiment, in response to detecting the multiplier symbol 542, the values of any active value-bearing symbols are updated based on the multiplier. In other embodiments additional (e.g., inactive value-bearing symbols) or fewer value-bearing symbols are updated in response to the multiplier symbol 542. In one example, the multiplier is only applied to new value-bearing symbols from the latest symbol outcome. In another example, a random number of value-bearing symbols may be selected to be updated based on the multiplier.

FIG. 7B depicts the game interface 500 in a second state following the first state. The second state depicts the result of applying the multiplier symbol 542 to the active value-bearing symbols 514, 528, and 536 as can been seen by the change in award indicia between FIGS. 7A and 7B. The multiplier may be applied through a multiplier sequence presented via the presentation assembly, which may include one or more animations and/or other visual changes to visibly convey the effect of the multiplier symbol 542 to other symbols.

In certain embodiments, the multiplier of the multiplier symbol 542 may be “queued” to be used within the next award sequence detected within the feature game. That is, the multiplier may be applied to one or more awards associated with the award sequence rather than being applied immediately in response to detecting and presenting the multiplier symbol 542.

In some embodiments, the multiplier symbols, other modifier symbols, and other symbols present within the feature game are available within the symbol outcomes. In such embodiments, the modifier symbols may be held similar to the value-bearing symbols and/or have different durations. In one example, progressive jackpot trigger symbols, which may trigger an award sequence associated with a progressive jackpot award, may be held within the symbol array for the entire remaining duration of the feature game. In another example, multiplier symbols (or the corresponding multiplier) are held within a symbol position until a value-bearing symbol occupies the position, where the co-occupation causes the multiplier to be applied to the value of the value-bearing symbol.

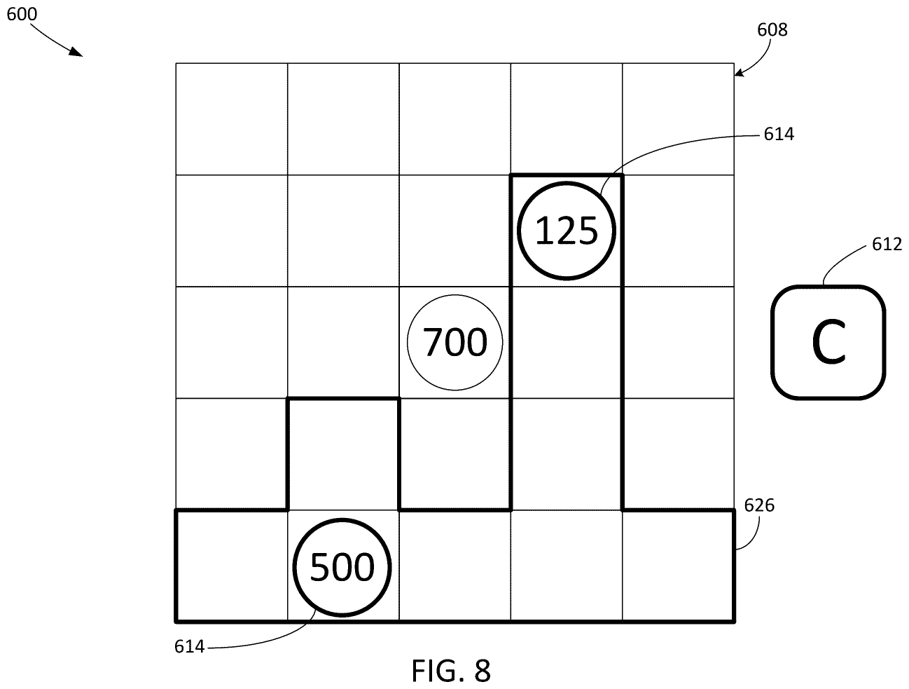

FIG. 8 depicts a game interface 600 that, while incorporating the three sub-outcomes associated with the feature game outcomes using the game interfaces 400, 500 shown in FIGS. 6A-7B, includes a different configuration of game and presentation elements. In particular, the game interface 600 includes a symbol array 608 selectively populated with symbols (e.g., value-bearing symbols 614) through a symbol outcome, an independent catalyst position 612 separate from the array 608, and a non-uniform activation zone 626. These game elements, unless otherwise specified herein or implied through the visual presentation of the game interface 600, may function similar to the game elements described above with respect to the game interfaces 400, 500. For example, the symbol positions of the symbol array 608 and the corresponding available symbols are configured to function similar to the corresponding elements of the other example embodiments.

The catalyst symbol position 612 is positioned separately from the symbol array 608 rather than occupying or converting a symbol position to a dedicated catalyst position. The catalyst symbol position 612 may be presented in response to initiating a feature game using a catalyst outcome, or the catalyst symbol position 612 may be used within a base game. For example, modifiers, feature game trigger events, and/or other suitable game events within the base game may be at least partially based on symbols occupying the catalyst symbol position 612. In the illustrated embodiment, the catalyst symbol position 612 is positioned to the right of the symbol array 608. In other embodiments, other suitable presentation configurations of the symbol array 608 and the catalyst symbol position 612 may be used. In certain embodiments, the game interface 600 includes multiple catalyst symbol positions, which may form an independent catalyst symbol array.

In other embodiments, in place of the catalyst symbol position 612, other suitable catalyst game elements are used to visibly convey a catalyst outcome. For example, the catalyst symbol position 612 may be replaced with a catalyst wheel having a plurality of wheel segments. In such an example, the catalyst outcome may be presented by animating a spin of the catalyst wheel and/or a corresponding selector and stopping the animation such that the selector visibly indicates a selection of one of the wheel segments. The selected wheel segment includes a corresponding game element (e.g., blanks, catalyst symbols, modifiers, etc.) that defines the catalyst outcome.

In the example embodiment, the activation zone 626 spans a plurality of symbol positions extending over multiple rows and columns of the symbol array 608. Unlike the activation zones shown with respect to the game interfaces 400, 500, the activation zone 626 is not aligned with a single row or column and can encompass a portion of a row or column. The activation zone 626 is randomly defined within the zone outcome. In one example, a plurality of stored activation zones is stored in one or more weighted tables, and the activation zone 626 is randomly selected in a selection process similar to selecting the symbols of the symbol outcome. In another example, the game-logic circuitry associated with the game interface 600 is configured to randomly determine for each symbol position or position subset whether or not the symbol positions are included within the activation zone 626. In a further example, one or more symbol positions are predetermined to be within the activation zone (e.g., a center symbol position, a rightmost column, the bottom row, etc.), and the game-logic circuitry randomly allocates the remaining positions of the activation zone. In such an example, with respect to FIG. 8 if the bottom row of the array 608 is predefined to be within the activation zone, the game-logic circuitry has four positions within the activation zone to allocate randomly to the remaining symbol positions (i.e., one to the second column and three to the fourth column). In some embodiments, the activation zone may not be required to form a single group of adjacent symbol positions. That is, the activation zone may include a plurality of positionally separate sub-zones within the array 608, where a sub-zone includes one or more symbol positions.

In the embodiments disclosed herein, each value-bearing symbol may be assigned a credit value that is displayed upon the symbol. The credit value may, for example, range from a minimum credit value to a maximum credit value and be based on the total amount wagered on the game. For example, if a player wagers a minimum of 100 credits, the assigned credit value may range from 100 to 1000 credits. And if a player wagers a maximum of 500 credits, the assigned credit value may proportionately increase and thereby range from 500 to 5000 credits. In some embodiments, the assigned value may be randomly selected from a list of possible multipliers of the total amount wagered on the game, for example, 1×, 2×, 3×, 4×, 5×, 10×, 15×, 20×, 50×, and 100×. In other embodiments, the value may be pre-assigned to each value-bearing symbol as part of the reel strip layouts of the game reels. In still other embodiments, the assigned value may be randomly selected before, during, or at the conclusion of a reel spin.

While the embodiments are largely described within the context of a feature or bonus game, it is equally contemplated that the disclosed embodiments can be practiced within the context of a base game incorporating wagers. Suitable adaptations of the embodiments to base game may be used, such as continuing the base game following the termination conditions described above.

The embodiments of the present invention provide an innovative procedure for accumulating, activating, and aggregating values of symbols in a symbol array. Game-logic circuitry executing instructions in accordance with the embodiments present a visual display of spinning reels with clearly enumerated symbology that combine in readily understood arrangements to increase in value. An observer experiences excitement and anticipation as new symbols land in the array and aggregate values are summed and displayed. Similarly, the activation of symbols through readily understood visual cues (e.g., clearly defined activation zones, changes to the symbols, etc.) provide excitement within a resource-efficient manner. In stark contrast to conventional reel-spinning games in which symbol images are evaluated for winning combinations by paytable rules, the disclosed embodiments provide immediately recognizable values in WYSIWYG display configurations while adding variability as to how the values to be awarded to the player are selected and accumulated.

The value-accumulation, symbol-activation, and value-aggregation procedures may be symbol-and game-agnostic. Themes and imagery of symbols and environment may be varied with no effect on these processes. Or, if so desired, the criteria for value-accumulation, symbol-activation, and/or value-aggregation may be modified in innumerable ways to produce new visual/animation effects and exciting summation sequences.

Further benefits are realized in increased computer processing efficiency, fewer rules to be evaluated, and simpler graphical representations. For example, in a conventional paytable evaluation, overlapping payline sections require multiple evaluation steps. Often, analysis is required to determine which payline results in the highest credit total, with the lesser value paylines being discarded but only after being evaluated-all this adds to processing overhead. Special symbols like wilds, multipliers, and scatter symbols can modify paytable values and may require separate, additional evaluation according to customized rule sets. All these procedures can be inherently more complex than simple accumulation, activation, and aggregation (i.e., addition) of number values. The embodiments disclosed herein represent a win-win: simpler, almost self-explanatory graphics combined with faster, more efficient processing. The inventive value-aggregation procedure can be implemented on the vast majority of casino gaming machines without requiring upgrades or modifications.

In this description, numerous specific details are set forth. However, it is understood that embodiments of the invention may be practiced without these specific details. In other instances, well-known circuits, structures, and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming machine comprising:
a presentation assembly configured to present a plurality of symbol positions and a catalyst game element; and
game-logic circuitry in communication with the presentation assembly, the game-logic circuitry configured to cause the presentation assembly to present a plurality of game outcomes, wherein, for each game outcome of the plurality of game outcomes, the game-logic circuitry is configured to:
cause the presentation assembly to present a zone outcome visually indicating an activation zone within the plurality of symbol positions;
cause the presentation assembly to present a symbol outcome by populating the plurality of symbol positions with randomly selected symbols from one or more sets of available symbols, the one or more sets of available symbols including value-bearing symbols having (i) award indicia that visually indicates an award value corresponding to the respective value-bearing symbol and (ii) an activation state comprising an active state and an inactive state;
in response to the randomly selected symbols including one or more value-bearing symbols within the activation zone, cause the presentation assembly to visually update the one or more value-bearing symbols to the active state;
cause the presentation assembly to present a catalyst outcome with the catalyst game element, the catalyst outcome selectively including a catalyst trigger; and
in response to detecting the catalyst trigger within the catalyst outcome, cause the presentation assembly to present an award sequence for an award at least partially as a function of the award indicia of any active state value-bearing symbols within the plurality of symbol positions.

2. The gaming machine of claim 1, wherein the value-bearing symbols of the one or more sets of available symbols initially are in the inactive state.

3. The gaming machine of claim 1, wherein the one or more value-bearing symbols, in response to updating to the active state, are held within the plurality of symbol positions for at least one subsequent game outcome.

4. The gaming machine of claim 1, wherein the catalyst game element includes a catalyst symbol position selectively occupied by a catalyst symbol, and wherein the catalyst trigger includes detecting the catalyst symbol within the catalyst symbol position.

5. The gaming machine of claim 4, wherein the plurality of symbol positions and the catalyst symbol position form a symbol array.

6. The gaming machine of claim 1, wherein the activation zone includes a first subzone and a second subzone positionally independent of the first subzone.

7. The gaming machine of claim 6, wherein the first subzone comprises a first column of a symbol array at least partially formed by the plurality of symbol positions and the second subzone comprises a second column of the symbol array.

8. The gaming machine of claim 1, wherein the activation zone replaces a previous activation zone from a prior game outcome, the activation zone being at least partially different from the previous activation zone.

9. A method for operating a gaming machine of a gaming system, the gaming system comprising a presentation assembly of the gaming machine and game-logic circuitry in communication with the presentation assembly, the method comprising:
presenting, by the presentation assembly, a plurality of symbol positions and a catalyst game element; and
causing, by the game-logic circuitry, the presentation assembly to present a plurality of game outcomes, wherein, each game outcome of the plurality of game outcomes includes the game-logic circuitry causing the presentation assembly to:
present a zone outcome visually indicating an activation zone within the plurality of symbol positions;
present a symbol outcome by populating the plurality of symbol positions with randomly selected symbols from one or more sets of available symbols, the one or more sets of available symbols including value-bearing symbols having (i) award indicia that visually indicates an award value corresponding to the respective value-bearing symbol and (ii) an activation state comprising an active state and an inactive state;
in response to the randomly selected symbols including one or more value-bearing symbols within the activation zone, visually update the one or more value-bearing symbols to the active state;
present a catalyst outcome with the catalyst game element, the catalyst outcome selectively including a catalyst trigger; and
in response to detecting the catalyst trigger within the catalyst outcome, present an award sequence for an award at least partially as a function of the award indicia of any active state value-bearing symbols within the plurality of symbol positions.

10. The method of claim 8, wherein the value-bearing symbols of the one or more sets of available symbols initially are in the inactive state.

11. The method of claim 8, wherein the one or more value-bearing symbols, in response to updating to the active state, are held within the plurality of symbol positions for at least one subsequent game outcome.

12. The method of claim 8, wherein the catalyst game element includes a catalyst symbol position selectively occupied by a catalyst symbol, and wherein the catalyst trigger includes detecting the catalyst symbol within the catalyst symbol position.

13. The method of claim 12, wherein the plurality of symbol positions and the catalyst symbol position form a symbol array.

14. The method of claim 8, wherein the activation zone includes a first subzone and a second subzone positionally independent of the first subzone.

15. The method of claim 14, wherein the first subzone comprises a first column of a symbol array at least partially formed by the plurality of symbol positions and the second subzone comprises a second column of the symbol array.

16. The method of claim 8, wherein the activation zone replaces a previous activation zone from a prior game outcome, the activation zone being at least partially different from the previous activation zone.

17. A gaming system comprising:
a gaming machine comprising a presentation assembly configured to present a plurality of symbol positions and a catalyst game element; and
game-logic circuitry in communication with the presentation assembly, the game-logic circuitry configured to cause the presentation assembly to present a plurality of game outcomes, wherein, for each game outcome of the plurality of game outcomes, the game-logic circuitry is configured to:
cause the presentation assembly to present a zone outcome visually indicating an activation zone within the plurality of symbol positions;
cause the presentation assembly to present a symbol outcome by populating the plurality of symbol positions with randomly selected symbols from one or more sets of available symbols, the one or more sets of available symbols including value-bearing symbols having (i) award indicia that visually indicates an award value corresponding to the respective value-bearing symbol and (ii) an activation state comprising an active state and an inactive state;
in response to the randomly selected symbols including one or more value-bearing symbols within the activation zone, cause the presentation assembly to visually update the one or more value-bearing symbols to the active state;
cause the presentation assembly to present a catalyst outcome with the catalyst game element, the catalyst outcome selectively including a catalyst trigger; and
in response to detecting the catalyst trigger within the catalyst outcome, cause the presentation assembly to present an award sequence for an award at least partially as a function of the award indicia of any active state value-bearing symbols within the plurality of symbol positions.

18. The gaming system of claim 17, wherein the value-bearing symbols of the one or more sets of available symbols initially are in the inactive state.

19. The gaming system of claim 17, wherein the one or more value-bearing symbols, in response to updating to the active state, are held within the plurality of symbol positions for at least one subsequent game outcome.

20. The gaming system of claim 17, wherein the catalyst game element includes a catalyst symbol position selectively occupied by a catalyst symbol, and wherein the catalyst trigger includes detecting the catalyst symbol within the catalyst symbol position.

21. The gaming system of claim 20, wherein the plurality of symbol positions and the catalyst symbol position form a symbol array.

22. The gaming system of claim 17, wherein the activation zone includes a first subzone and a second subzone positionally independent of the first subzone.

23. The gaming system of claim 22, wherein the first subzone comprises a first column of a symbol array at least partially formed by the plurality of symbol positions and the second subzone comprises a second column of the symbol array.

24. The gaming system of claim 17, wherein the activation zone replaces a previous activation zone from a prior game outcome, the activation zone being at least partially different from the previous activation zone.
